(19) United States
(12) Patent Application Publication
(10) Pub. No.: US 2005/0231168 A1
(43) Pub. Date: Oct. 20, 2005

(54) Mobile communication device having protection circuit on handset side

(75) Inventor: Chao-Hua Lin, Taoyuan (TW)

Correspondence Address: Richard P. Berg, Esq.;c/o LADAS & PARRY, Suite 2100, 5670 Wilshire Boulevard, Los Angeles, CA, 90036-5679, US

(73) Assignee: BENQ CORPORATION

(21) Appl. No.: 11/043,845

(22) Filed: Jan. 25, 2005

(30) Foreign Application Priority Data
Apr. 14, 2004 (TW) 093110421

(51) Int. Cl. H02J 7/00

(52) U.S. Cl. 320/134

(57) ABSTRACT

The invention provides a hand-held electric device and a method for protecting the main circuit of the device. The device includes a housing, a main circuit installed within the housing, a protection circuit installed within the housing, and a battery detachably attached to the housing. When the battery is attached to the housing, the battery electrically connects with the main circuit to form a loop, so as to provide electric power for operations of the main circuit. The protection circuit includes a protection controller and a control switch installed in the loop. When the protection controller detects an abnormal voltage or current, the protection controller transmits a protection control signal to the control switch to cut off the loop, so as to protect the main circuit from being damaged by the abnormal voltage or current.

### BACKGROUND OF THE INVENTION

1. Field of the Invention

This present invention relates to a hand-held electric device and a method of protecting the main circuit of the device, especially for a type of protection circuit device and the protection method used between a mobile communication device and a detachable battery.

2. Description of the Prior Art

Consumers not only demand multi-functions and attractive appearance when they choose a mobile communication device, but safety in using the device is an important issue too. In consideration of safety issues, the battery of a mobile communication device normally comprises a protection mechanism to protect the mobile communication device from being damaged by abnormal operations. Protection mechanisms of mobile communication devices of the prior art are divided into three types. The first type of protection mechanism is the protection circuit installed within a battery to cut off abnormal voltage or current during charging or discharging in a mobile communication device. The second type of protection mechanism is a thermal sensitive resistor. The voltage and temperature in the core of the battery will continuously rise when the battery is being charged by the charger; thus, the thermal sensitive fuse can cut off the charging or discharging of the battery if there is overheating. The third type of protection mechanism is a discharging pump mechanism installed within the core of a battery.

The three types of protection mechanism are all installed within the battery. In consideration of cost, however, many manufacturers replace the internal protection device of the original battery with low quality devices. When an original device is used with a non-original battery, this can possibly cause safety problems. In addition, users can never know whether the protection mechanism is installed within a battery. Furthermore, users may unknowingly use an unstable battery charger for charging battery. Therefore, by using a low quality battery with an unstable battery charger, the safety of the user is being further threatened.

Thus, the main objective of this invention relates to a hand-held electric device and a method of protecting the main circuit of the device, so as to protect the device from being damaged by abnormal voltage or current during charging or discharging of the battery of the device.

### SUMMARY OF THE INVENTION

An objective of the present invention is to provide a hand-held electric device and a method of protecting the main circuit of the device to solve the problems of the prior art.

Another objective of the invention is to provide a hand-held electric device and a method of protecting the main circuit of the device, so as to avoid the situation where a user may unknowingly use a low quality battery with a battery charger without protection mechanism, which could have safety problems.

Another purpose of the invention is to provide a hand-held electric device and a method of protecting main circuit of the device by forming a double protection on both the device side and the battery side, so as to avoid safety problems that can be caused by using original device with non-original battery.

The invention is to provide a hand-held electric device and a method of protecting the main circuit of the device. The hand-held electric device comprises a housing, a main circuit, a detachable battery, and a first protection circuit. The main circuit and the first protection circuit are installed within the housing. The battery is detachably attached to the housing. When the battery is attached to the housing, the battery electrically connects with the main circuit to form a loop, such that the battery provides electric power for operations of the main circuit. The first protection circuit comprises a first protection controller and a first control switch installed in the loop. When the first protection controller detects an abnormal voltage or current occurring in the loop, the first protection controller transmits a protection control signal to the first control switch to cut off the loop, so as to protect the main circuit from being damaged by the abnormal voltage or current.

In the hand-held electric device and the protection method of the main circuit of the device of the present invention, the protection controller and the control switch, which are installed within the housing, protect the main circuit from being damaged by abnormal voltage or current. When the invention is applied in a mobile communication device, like a cell-phone, both the main circuit of the device and the battery can be protected from being damaged by abnormal voltage or current even when a low quality battery and/or a charger without protection mechanism are being used.

The advantage and spirit of the invention may be understood by the following recitations together with the appended drawings.

### BRIEF DESCRIPTION OF THE APPENDED DRAWINGS

FIG. 1 is a schematic diagram of the hand-held electric device of the present invention.

FIG. 2 is a circuit diagram of the first protection circuit of the first embodiment in FIG. 1.

FIG. 3 is a schematic diagram of the controlling of the charging loop by the first transistor switch in the first protection circuit during the charging of a battery in FIG. 2.

FIG. 4 is a flow chart of the method of protecting the main circuit in the hand-held electric device during the charging of a battery in FIG. 1.

FIG. 5 is a flow chart of the method of protecting the main circuit in the hand-held electric device during the discharging of a battery in FIG. 1.

### DETAILED DESCRIPTION OF THE INVENTION

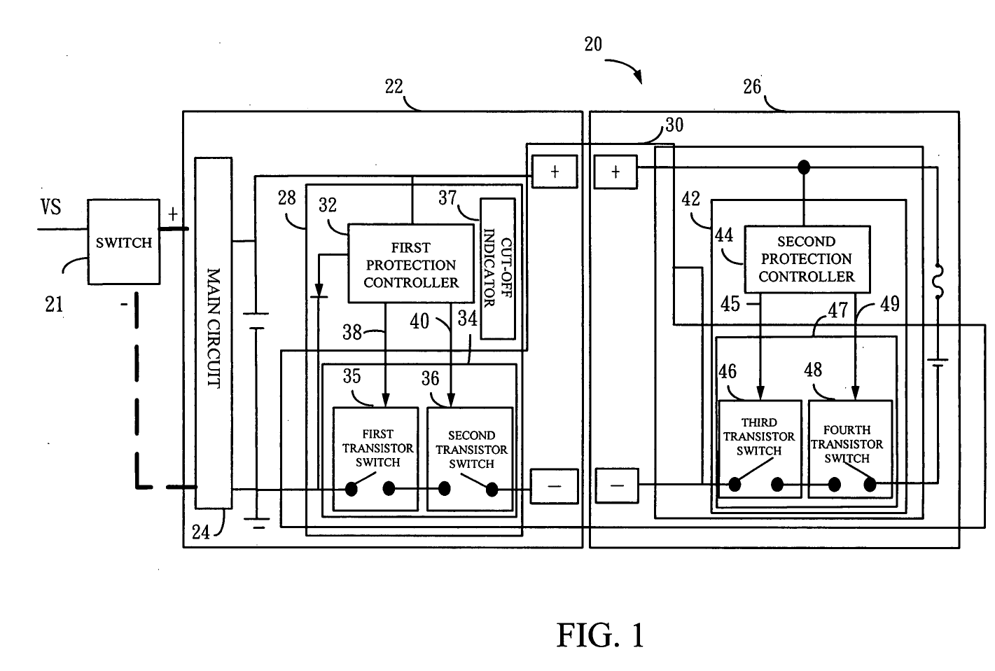

Referring to FIG. 1, FIG. 1 is schematic diagram of the hand-held electric device of the present invention. The hand-held electric device 20 of the invention comprises a housing 22, a main circuit 24, a detachable battery 26, and a first protection circuit 28. The main circuit 24 and the first protection circuit 28 are installed within the housing 22. The battery 26 is detachably attached to the housing 22. When the battery 26 is attached to the housing 22, the battery 26 electrically connects with the main circuit 24 to form a loop 30, such that the battery 26 provides electric power for operations of the main circuit 24. As shown in FIG. 1, there is also a switch 21 which can provide electric power for the main circuit 24 of the hand-held electric device 20. The first protection circuit 28 comprises a first protection controller 32, a first control switch 34, and a cut-off indicator 37. The first control switch 34 comprises a first transistor switch 35 and a second transistor switch 36 installed in the loop 30. The first transistor switch 35 and the second transistor switch 36 are a P-type metal-oxide semiconductor field effect transistor (MOSFET) switch and an N-type MOSFET respectively.

The loop 30, formed by the main circuit 24 and the battery 26, comprises a charging loop 25 and a discharging loop 27; the first control switch comprises a first transistor switch 35, connected in series with the charging loop 25, and a second transistor switch 36 connected in series with the discharging loop 27.

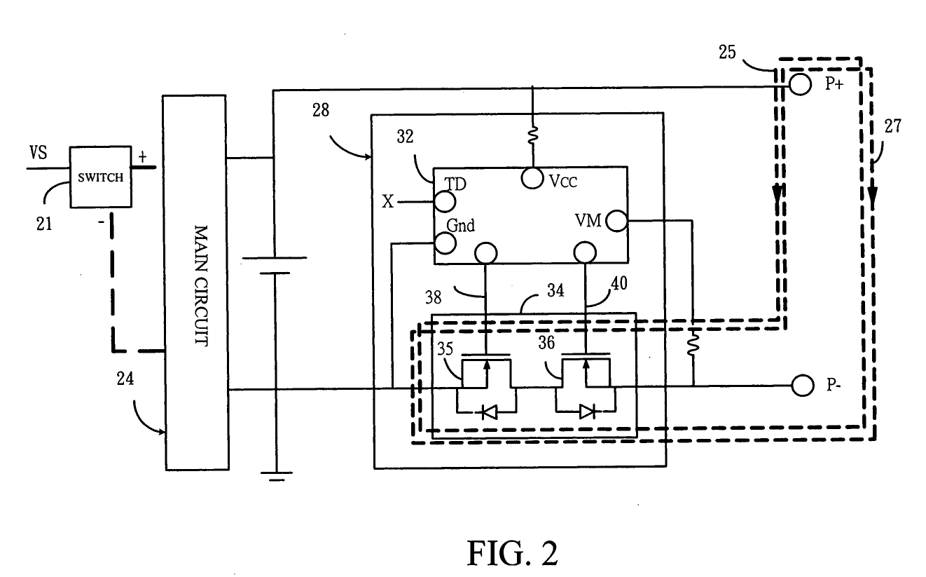

Referring to FIG. 2, FIG. 2 is the circuit diagram of an embodiment of the first protection circuit 28 as shown in FIG. 1. From the embodiment of FIG. 2, the direction of the current of the charging loop 25 of the loop 30, from P+ to P−, is anticlockwise during the charging of the battery. The first protection circuit 32 will transmit the first protection control signal 38 to the first transistor switch 35 to cut off the charging of the battery if there is excessive charging. However, the clockwise direction current can still flow through the left side of the first transistor switch 35 to the main circuit 24. The direction of the current of the discharging loop 27 of the loop 30, from P+ to P−, is clockwise during the discharging of the battery. The first protection circuit 32 will transmit the first protection control signal 40 to the second transistor switch 36 to cut off the discharging of the battery if there is excessive discharging. However, the anticlockwise direction current can still flow through the left side of the second transistor switch 36 to the battery 26.

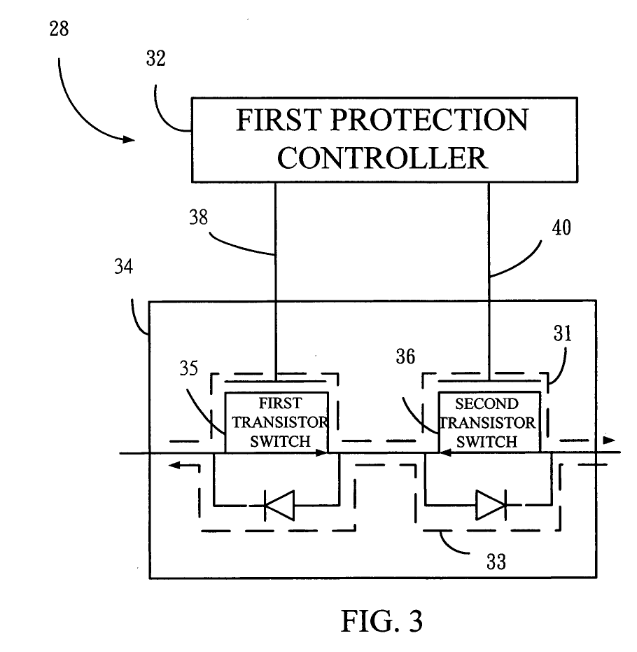

Referring to FIG. 3, FIG. 3 is the schematic diagram of the controlling of the charging loop 25 by the first transistor switch 35 in the first protection circuit 28 during the charging of the battery as shown in FIG. 2. Referring to FIG. 3, the charging loop 25 comprises a first current 31 and a second current 33. When the first protection controller 32 detects the abnormal voltage or current during the charging of the battery, the first protection controller 32 transmits the first protection control signal 38 to the first transistor switch 35 to cut off the first current 31, in order to cut off the charging loop 25 formed by the main circuit 24 and the battery 26. At the same time, because the second current 33 still exists, the battery keeps providing electric power for the operation of the main circuit 24 (as shown in FIG. 1). The cut-off indicator 37 then generates a message indicative of the cutting-off of the charging loop. The range of abnormal voltage or current is known by testing the stability of the core of battery 26. In an embodiment, the range of abnormal voltage is below 2.75 Volts or beyond 4.32 Volts, and the abnormal current is beyond 2.5 Amperes.

In an embodiment, the cut-off indicator 37 is a light emitting diode (LED). When the charging loop 25, formed by the main circuit 24 and the battery 26, is cut off, the cut-off indicator 37 generates a message indicative of the cutting-off of the charging loop. In other words, the light emitting diode of the cut-off indicator 37 is turned on to emit a light indicative of the cutting-off of the charging loop.

The hand-held electric device 20 of the invention comprises a first protection controller 32. When the first protection controller 32 detects the abnormal voltage or current in the loop 30, the first protection controller 32 transmits the first protection control signal 38 or 40 to the corresponding first transistor switch 35 or the second transistor switch 36 to cut off the loop 30, so as to protect the main circuit 24 from being damaged by the abnormal voltage or current.

Referring again to FIG. 1, in an embodiment of the invention, the battery 26 is a Li-ion battery or Li-Polymer battery; the battery 26 comprises a second protection circuit 42. The second protection circuit 42 comprises a second protection controller 44 and a second control switch 47. The second control switch 47 comprises a third transistor switch 46 and a fourth transistor 48. When the second protection controller 44 detects the abnormal voltage or current during the charging or discharging of the battery, the second protection controller 44 transmits a second protection control signal 45 or a second protection control signal 49 to the third transistor switch 46 and the fourth transistor switch 48 to cut off the loop 30 formed by the main circuit 24 and the battery 26, so as to protect the main circuit 24 and the battery 26 from being damaged by the abnormal voltage or current. During the charging of the battery, when the second protection controller 44 detects the abnormal voltage or current, the second protection controller 44 controls the third transistor switch 46 to cut off the loop 30 formed by the main circuit 24 and the battery 26. During the discharging of the battery, when the second protection controller 44 detects the abnormal voltage or current, the second protection controller 44 controls the fourth transistor switch 48 to cut off the loop 30 formed by the main circuit 24 and the battery 26.

The hand-held electric device 20 of the invention comprises the first protection controller 32 and the second protection controller 44. In other words, the invention forms a double protection mechanism on both the device side and the battery side to protect the hand-held electric device 20 from being damaged by abnormal voltage or current. The main circuit 24 of the hand-held electric device 20 can be protected from being damaged by abnormal voltage or current even when a low quality battery and/or charger without protection mechanism are being used.

When the hand-held electric device 20 of the present invention is applied in a mobile communication device, like a cell-phone, the right side of the housing 22 in FIG. 1 is the battery connector of the cell-phone, and the left side of the battery 26 in FIG. 1 is the battery pad of the battery. The first protection circuit 28 and the second protection circuit 42 form a double protection on both the cell-phone side and the battery side. When the invention is used in a cell-phone, the main circuit of the cell-phone can be protected from being damaged by abnormal voltage or current because of the protection circuit installed within the cell-phone; furthermore, the cut-off indicator reduces the anxiety of users about safety issues by warning users in an abnormal situation. Thus, users never have to worry about safety problem possibly caused by using a non-original battery and/or a non-original battery charger.

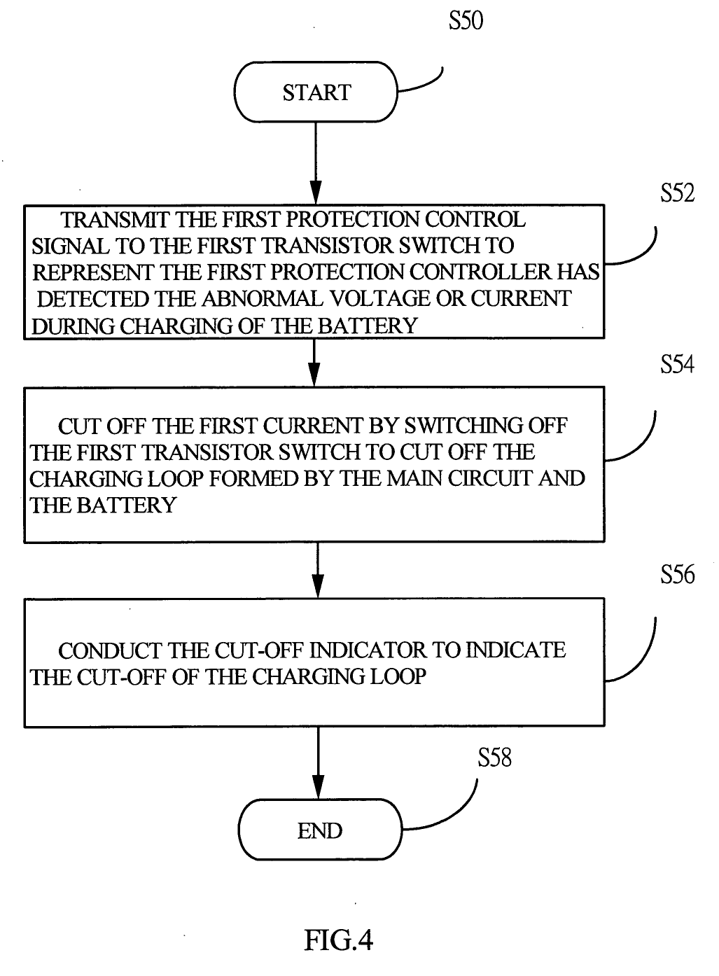

Referring to FIG. 4, FIG. 4 is a flow chart of the method of protecting the main circuit 24 of the hand-held electric device 20 as shown in FIG. 1 during the charging of the battery 26. The invention also provides a protection method for the main circuit of a hand-held electric device; the hand-held electric device comprises a housing, within which the main circuit is installed, and a battery detachably attached to the housing. When the battery is attached to the housing, the battery electrically connects with the main circuit to form a loop, such that the battery provides electric power for operations of the main circuit. The invention protects the main circuit from being damaged by abnormal voltage or current.

The method of present invention can be described together with FIG. 1. In the present protection method for the main circuit 24 of a hand-held electric device 20, the invention provides the first protection circuit 28 installed within the housing 22. In the protection method for the main circuit 24 of the hand-held electric device 20, when the first protection circuit 28 detects abnormal voltage or current during the charging of the battery, the first protection circuit 28 protects the main circuit 24 with the following steps:
Step S50: Start;
Step S52: Transmit the first protection control signal 38 to the first transistor switch 35 to represent that the first protection controller 32 detects abnormal voltage or current during the charging of the battery;
Step S54: Cut off the first current 31 by switching off the first transistor switch 35 to cut off the charging loop 25 formed by the main circuit 24 and the battery 26;
Step S56: Conduct the cut-off indicator 37 to indicate the cutting-off of the charging loop; and
Step S58: End.

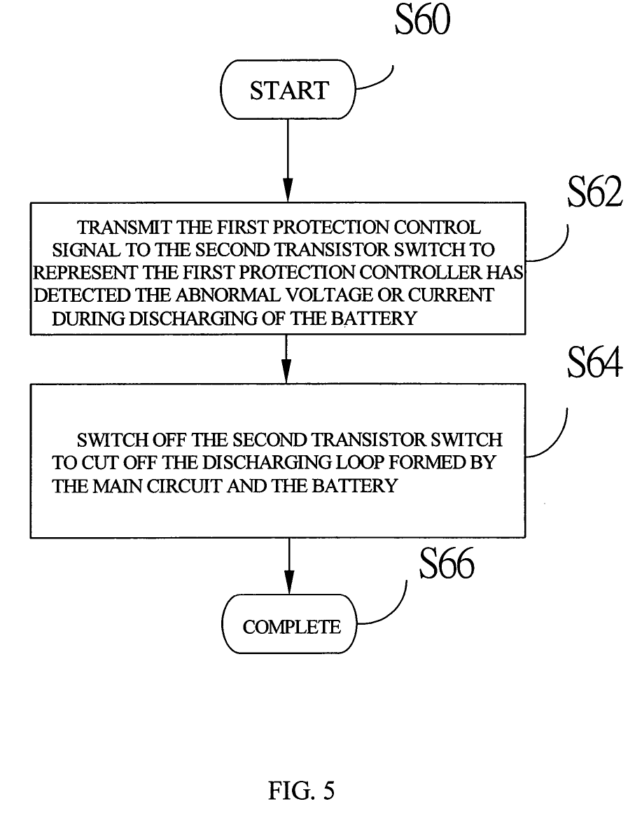

Referring to FIG. 5, FIG. 5 is a flow chart of the method of protecting the main circuit 24 of the hand-held electric device 20 shown in FIG. 1 during the discharging of the battery 26. In the protection method for the main circuit 24 of the hand-held electric device 20, when the first protection circuit 28 detects abnormal voltage or current during the discharging of the battery, the first protection circuit 28 protects the main circuit 24 with the following steps:
Step S60: Start;
Step S62: Transmit the first protection control signal 40 to the second transistor switch 36 to represent that the first protection controller 32 detects abnormal voltage or current during the discharging of the battery;
Step S64: Switch off the second transistor switch 36 to cut off the discharging loop 27 formed by the main circuit 24 and the battery 26;
Step S66: End.

Comparing with the prior art, because of the installation of the protection controller and control switch within the electric device, the present protection method for the main circuit of the hand-held electric circuit device can protect the main circuit from being damaged by abnormal voltage or current. When the invention is applied in a mobile communication device, like a cell-phone, the invention forms a double protection on both the cell-phone side and the battery side. In other words, by using the hand-held electric device of the present, the main circuit of the device can be protected from being damaged by abnormal voltage or current even when a low quality battery and/or a battery charger without protection mechanism are used.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

1. A hand-held electric device, said device comprising:
a housing;
a main circuit installed within the housing;
a battery detachably attached to the housing, when the battery is attached to the housing, the battery electrically connects with the main circuit to form a loop such that the battery provides electric power for the operation of the main circuit;
a first protection circuit installed within the housing, the first protection circuit comprising a first protection controller and a first control switch installed in the loop; and
wherein when the first protection controller detects an abnormal voltage or current occurring in the loop, the first protection controller transmits a protection control signal to the first control switch to cut off the loop, so as to protect the main circuit from being damaged by the abnormal voltage or current.

2. The hand-held electric device of claim 1, wherein the first control switch comprises a P-type metal-oxide semiconductor field effect transistor (MOSFET) switch and an N-type MOSFET, which are both connected in series with the loop, respectively.

3. The hand-held electric device of claim 1, wherein the loop, formed by the main circuit and the battery, comprises a charging loop and a discharging loop, the first control switch comprises a first transistor switch, connected in series with the charging loop, and a second transistor switch connected in series with the discharging loop.

4. The hand-held electric device of claim 3, wherein when the first protection controller detects the abnormal voltage or current during the charging of the battery, the first protection controller transmits the first protection control signal to the first transistor switch to cut off the charging loop formed by the main circuit and the battery.

5. The hand-held electric device of claim 3, wherein when the first protection controller detects the abnormal voltage or current during discharging of the battery, the first protection controller transmits the first protection control signal to the second transistor switch to cut off the discharging loop formed by the main circuit and the battery.

6. The hand-held electric device of claim 3, wherein the first protection circuit also comprises a cut-off indicator, when the charging loop, formed by the main circuit and the battery, is cut off, the cut-off indicator generating a message indicative of the cutting-off of the charging loop.

7. The hand-held electric device of claim 6, wherein the cut-off indicator is a light emitting diode (LED), when the charging loop, formed by the main circuit and the battery, is cut off, the light emitting diode is turned on to emit a light indicative of the cutting-off of the charging loop.

8. The hand-held electric device of claim 1, wherein the abnormal voltage is below 2.75 Volts or beyond 4.32 Volts.

9. The hand-held electric device of claim 1, wherein the abnormal current is beyond 2.5 Amperes.

10. The hand-held electric device of claim 1, wherein the battery is a Li-ion battery or a Li-Polymer battery, said device further comprises a second protection circuit installed near the battery, the second protection circuit comprises a second protection controller and a second control switch, when the second protection controller detects the abnormal voltage or current during charging or discharging of the battery, the second protection controller transmits a second protection control signal to the second transistor switch to cut off the loop formed by the main circuit and the battery, so as to protect the main circuit and the battery from being damaged by the abnormal voltage or current.

11. A protection method for a main circuit of a hand-held electric device, the hand-held electric device also comprises a housing, within which the main circuit is installed, and a battery detachably attached to the housing, when the battery is attached to the housing, the battery electrically connects with the main circuit to form a loop such that the battery provides electric power for operation of the main circuit, said method comprising the steps of:
providing a first protection circuit installed within the housing, the first protection circuit comprising a first protection controller and a first control switch installed on the loop;
detecting condition of voltage or current on the loop via the first protection controller;
transmitting, by the first protection controller, a protection control signal to the first control switch when the first protection controller detects an abnormal voltage or current in the loop; and
turning off the first control switch to cut off the loop, so as to protect the main circuit from being damaged by the abnormal voltage or current.

12. The protection method of claim 11, wherein the first control switch comprises a P-type metal-oxide semiconductor field effect transistor (MOSFET) switch and an N-type MOSFET switch, which are both connected in series with the loop, respectively.

13. The protection method of claim 11, wherein the loop, formed by the main circuit and the battery, comprises a charging loop and a discharging loop, the first control switch comprises a first transistor switch, connected in series with the charging loop, and a second transistor switch connected in series with the discharging loop.

14. The protection method of claim 13, wherein when the first protection controller detects the abnormal voltage or current during charging of the battery, the first protection controller transmits the first protection control signal to the first MOSFET switch to cut off the charging loop formed by the main circuit and the battery.

15. The protection method of claim 13, wherein when the first protection controller detects the abnormal voltage or current during the discharging of the battery, the first protection controller transmits the first protection control signal to the second (MOSFET) switch to cut off the discharging loop formed by the main circuit and the battery.

16. The protection method of claim 13, wherein the first protection circuit also comprises a cut-off indicator, when the charging loop, formed by the main circuit and the battery, is cut off, the cut-off indicator generates a message indicative of the cutting-off of the charging loop.

17. The protection method of claim 16, wherein the open circuit indicator is a light emitting diode (LED), when the charging loop, formed by the main circuit and the battery, is cut off, the light emitting diode is turned on to emit a light indicative of the cutting-off of the charging loop.

18. The protection method of claim 11, wherein the abnormal voltage is below 2.75 Volts or beyond 4.32 Volts.

19. The protection method of claim 11, wherein the abnormal current is beyond 2.5 Amperes.

20. The protection method of claim 1, wherein the battery is a Li-ion battery or a Li-Polymer battery, said method further comprises the step of:
providing a second protection circuit installed near the battery, the second protection circuit comprising a second protection controller and a second control switch, wherein when the second protection controller detects the abnormal voltage or current during charging or discharging of the battery, the second protection controller transmits a second protection control signal to the second transistor switch to cut off the loop formed by the main circuit and the battery, so as to protect the main circuit and the battery from being damaged by the abnormal electric voltage or current.
